(19) United States
(12) Patent Application Publication
(10) Pub. No.: US 2026/0141924 A1
(43) Pub. Date: May 21, 2026

(54) DAMPING STRUCTURE AND ELECTRONIC DEVICE

(71) Applicants: INVENTEC (PUDONG) TECHNOLOGY CORPORATION, Shanghai (CN); INVENTEC CORPORATION, Taipei City (TW)

(72) Inventors: Hsin-Haou HUANG, Taipei City (TW); Pin-Chieh CHEN, Taipei City (TW); Po-Hsiu CHEN, Taipei City (TW); Hsieh-Liang TSAI, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 19/221,643

(22) Filed: May 29, 2025

(30) Foreign Application Priority Data
Nov. 20, 2024 (CN) 202411669313.6

(51) Int. Cl. G11B 33/08; G11B 25/04

(52) U.S. Cl. CPC G11B 33/08; G11B 25/043

(57) ABSTRACT

An electronic device includes a chassis, a hard disk drive, at least one fan and a damping structure. The hard disk drive is disposed in the chassis. The at least one fan is disposed in the chassis. The damping structure is located between the hard disk drive and the at least one fan, and includes an elastic member and a mass block. The elastic member includes a mounting portion, a supporting portion and a swinging portion. The mounting portion is configured to be disposed in the chassis. Two opposite ends of the supporting portion are respectively connected to the mounting portion and the swinging portion. The mounting portion and the swinging portion are located on a side of the supporting portion. The swinging portion is swingable relative to the supporting portion and the mounting portion. The mass block is disposed on the swinging portion.

### CROSS-REFERENCE TO RELATED APPLICATIONS

This non-provisional application claims priority under 35 U.S.C. § 119(a) on Patent Application No(s). 202411669313.6 filed in China, on Nov. 20, 2024, the entire contents of which are hereby incorporated by reference.

### BACKGROUND OF THE INVENTION

### Technical Field of the Invention

The invention relates to a damping structure and an electronic device, more particularly to a damping structure and an electronic device including an elastic member and a mass block.

### Description of the Related Art

With the rapid development of technology, the computation performance of processors of an electronic product is improved significantly, while a large amount of heat is generated thereby at the same time. In order to prevent the damage to the processors caused by such heat, a fan is generally provided in the electronic product to cool the processors, so that the processors can operate within an adequate temperature range.

The fan operating in a high speed may generate vibration. When such vibration is transferred to a hard disk drive disposed in the electronic product, a position error signals (PES) may be caused in the operating hard disk drive, thereby adversely affecting an accuracy of data reading and causing a poor read speed of the hard disk drive, for example, causing a low input/output per second (IOPS). Accordingly, an overall performance of the electronic product may be degraded, and data loss may even be caused. Thus, a vibration suppression is critical in the field of the electronic product. Generally, manufactures may additionally assemble a damping member in a chassis of the electronic product to absorb the vibration generated by the fan. However, the conventional damping member is expensive. In addition, it is hard to assemble the damping member in the chassis due to excessive components of the damping member and limited inner space of the chassis. Moreover, the conventional damping member cannot be compatible with different specifications of the chassis. That is, the manufactures need to adopt different sizes of the damping member for different specifications of the chassis, thereby increasing an assembly cost of the damping member. Therefore, lowering the assembly cost while maintaining the damping effect of the damping member is one of the key issues that researchers need to address.

### SUMMARY OF THE INVENTION

The invention provides a damping structure and an electronic device in order to lower the assembly cost while maintaining the damping effect of the damping structure.

One embodiment of the invention provides a damping structure configured to be disposed in a chassis. The damping structure includes an elastic member and a mass block. The elastic member includes a mounting portion, a supporting portion and a swinging portion. The mounting portion is configured to be disposed in the chassis. Two opposite ends of the supporting portion are respectively connected to the mounting portion and the swinging portion. The mounting portion and the swinging portion are located on a side of the supporting portion. The swinging portion is swingable relative to the supporting portion and the mounting portion. The mass block is disposed on the swinging portion.

Another embodiment of the invention provides an electronic device including a chassis, a hard disk drive, at least one fan and at least one damping structure. The hard disk drive is disposed in the chassis. The at least one fan is disposed in the chassis. The damping structure is located between the hard disk drive and the at least one fan, and includes an elastic member and a mass block. The elastic member includes a mounting portion, a supporting portion and a swinging portion. The mounting portion is disposed in the chassis. Two opposite ends of the supporting portion are respectively connected to the mounting portion and the swinging portion. The mounting portion and the swinging portion are located on a side of the supporting portion. The swinging portion is swingable relative to the supporting portion and the mounting portion. The mass block is disposed on the swinging portion.

According to the damping structure and the electronic device disclosed in the above embodiment, the two opposite ends of the supporting portion are respectively connected to the mounting portion and the swinging portion, and the mounting portion and the swinging portion are located on the same side of the supporting portion, such that the elastic member is, for example, shaped like a numeral “7”. The swinging portion is swingable relative to the supporting portion and the mounting portion. The natural frequency of the damping structure can be correspondingly adjusted by adjusting the mass of the mass block and the position in which the mass block is disposed in the assembling recess. Therefore, the vibration can be damped by the damping structure of the electronic device effectively under different operating conditions. When the natural frequency of the damping structure matches a vibration frequency of the at least one fan, a resonance will be generated, and the strong amplitude enhancement effect may be generated by the damping structure. The interaction between the vibration generated by the at least one fan during operation and the elastic member of the damping structure can be conducted along the path where the vibration is transferred. Specifically, the vibration generated by the at least one fan during operation may be transferred to the elastic member of the damping structure. The swinging portion can absorb the vibration effectively, and convert the vibration into kinetic energy of the swinging portion. Accordingly, the vibration generated by the at least one fan during operation can be confined within the damping structure, thereby dissipating, for example, 71% of a total vibrating energy and 53% of a peak vibrating energy. In addition, the damping structure can be facilitated to be assembled in the limited space between the hard disk drive and the at least one fan and be prevented from interfering with other obstructions disposed in the aforementioned space, and thus, the damping structure can be adaptable to different specifications of the chassis. Accordingly, the assembly cost of the damping structure can be lowered while maintaining the damping effect of the damping structure.

### BRIEF DESCRIPTION OF THE DRAWINGS

The invention will become more fully understood from the detailed description given herein below and the accompanying drawings which are given by way of illustration only and thus are not limitative of the invention and wherein:

FIG. 1 is a plane view of an electronic device in accordance with an embodiment of the invention;

FIG. 2 is a perspective view of one of damping structures of the electronic device in FIG. 1;

FIG. 3 is a plane view of one of the damping structures of the electronic device in FIG. 2;

FIG. 4 is an exploded view of one of the damping structures of the electronic device in FIG. 2;

FIG. 5 is a top view of an elastic member of one of the damping structures of the electronic device in FIG. 2; and

FIG. 6 is a side view of the elastic member of one of the damping structures of the electronic device in FIG. 2.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the invention, such as technical and scientific terms, have its own meanings and can be comprehended by those skilled in the art, unless the terms are additionally defined in the invention. That is, the terms used in the following paragraphs should be read on the meaning commonly used in the related fields and will not be overly explained, unless the terms have a specific meaning in the invention.

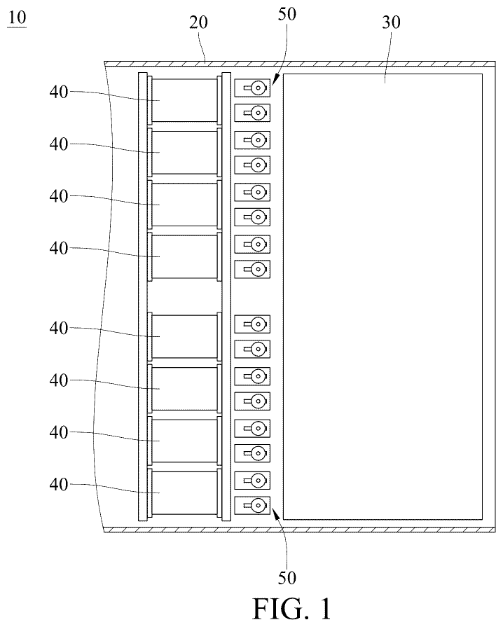

Please refer to FIG. 1, which is a plane view of an electronic device 10 in accordance with an embodiment of the invention. In this embodiment, the electronic device 10 includes a chassis 20, a hard disk drive 30, a plurality of fans 40 and a plurality of damping structures 50. The hard disk drive 30 and the fans 40 are disposed in the chassis 20. The damping structures 50 are disposed between the hard disk drive 30 and the fans 40 as local resonators, such that an interaction between vibrations generated by the fans 40 during operation and the damping structures 50 can be conducted along a path where the vibrations are transferred. Therefore, the vibrations generated by the fans 40 during operation can be damped. Accordingly, the read speed of the hard disk drive 30, such as input/output per second (IOPS) of the hard disk drive 30, is prevented from being reduced by the vibrations.

When a frequency of external vibrations is nearly equal to a resonant frequency of the damping structures 50, a local resonance of the local resonators can be induced to form a vibration bandgap. The local resonance is caused by the interaction between a mass component and elastic waves generated by elastic members of the local resonators, thereby enhancing the vibration suppression effect. In addition, the vibrations of a frequency ranging from, for example, 300 hertz (Hz) to 400 Hz and 1200 Hz to 1500 Hz can be absorbed by the damping structures 50. Moreover, a fundamental frequency and overtones thereof around 300 Hz to 400 Hz are, for example, a fundamental frequency of the vibrations generated by the fans 40 during operation, and a frequency ranging from 1200 Hz to 1500 Hz is, for example, a sensitive frequency in which the hard disk drive 30 is susceptible to the vibrations.

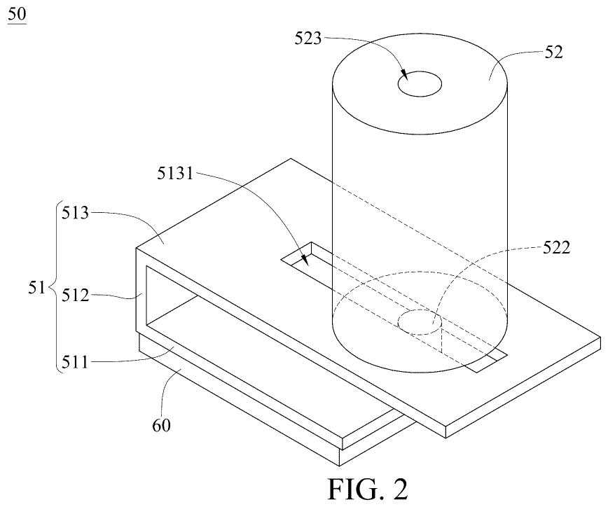

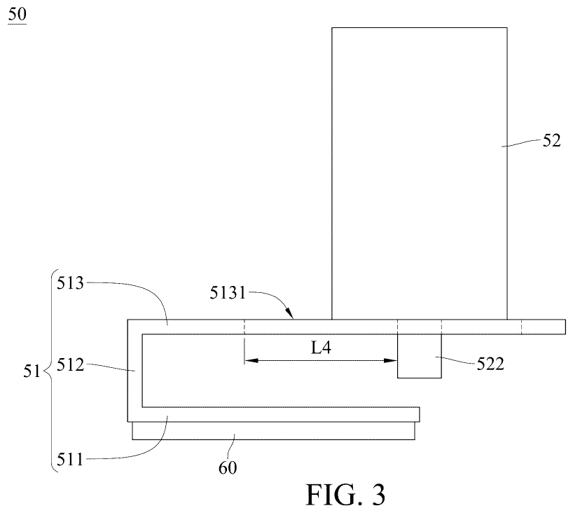

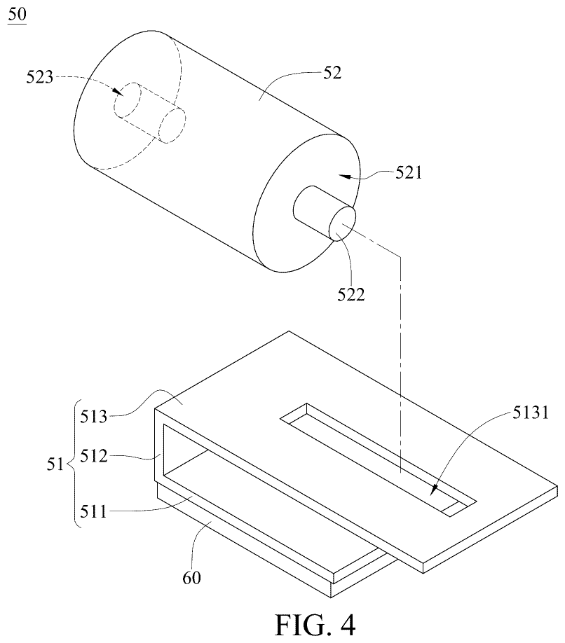

Please refer to FIG. 1 to FIG. 4, where FIG. 2 is a perspective view of one of the damping structures 50 of the electronic device 10 in FIG. 1, FIG. 3 is a plane view of one of the damping structures 50 of the electronic device 10 in FIG. 2, and FIG. 4 is an exploded view of one of the damping structures 50 of the electronic device 10 in FIG. 2.

Each of the damping structures 50 includes an elastic member 51 and a mass block 52. That is, the elastic member 51 and the mass block 52 together form a resonator, and a natural frequency of the resonator follows the equation:

$$f = \frac{1}{2 π} \sqrt{\frac{k}{m}} ,$$

where the symbol “f” in the aforementioned equation refers to the natural frequency (unit: hertz, Hz) of the resonator, the symbol “k” in the aforementioned equation refers to a stiffness (unit: newtons per meter, N/m) of the elastic member 51, and the symbol “m” in the aforementioned equation refers to a mass (unit: kilograms, kg) of the mass block 52.

The elastic member 51 includes a mounting portion 511, a supporting portion 512 and a swinging portion 513. The mounting portion 511 is disposed in the chassis 20. Specifically, the mounting portion 511 is fixed to the chassis 20 via, for example, a magnetic member 60. Two opposite ends of the supporting portion 512 are connected to the mounting portion 511 and the swinging portion 513, and the mounting portion 511 and the swinging portion 513 are located on the same side of the supporting portion 512. The swinging portion 513 is swingable relative to the supporting portion 512 and the mounting portion 511.

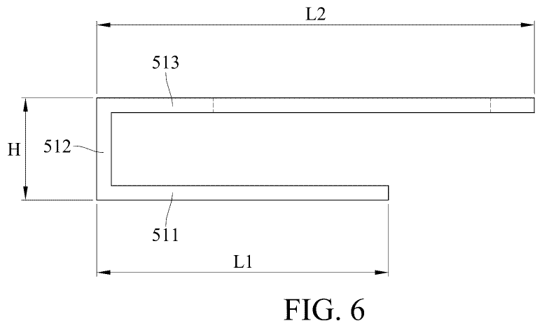

The elastic member 51 is made of a material such as metal, acrylic, resin or plastic. In addition, please refer to FIG. 6 temporarily, which is a side view of the elastic member 51 of one of the damping structures 50 of the electronic device 10 in FIG. 2. A length L2 of the swinging portion 513 is, for example, greater than a length L1 of the mounting portion 511, such that the elastic member 51 is, for example, shaped like a numeral “7”.

The mass block 52 is disposed on the swinging portion 513. Specifically, the swinging portion 513 has an assembling recess 5131, and the mass block 52 has a surface 521 and an assembling protrusion 522. The surface 521 is, for example, flat. The assembling protrusion 522 is, for example, a bolt, and protrudes from the surface 521. The assembling protrusion 522 is movably disposed in the assembling recess 5131. In addition, when the swinging portion 513 is thin enough for the assembling protrusion 522 to be disposed therethrough, a nut (not shown) can additionally be fastened to the portion of the assembling protrusion 522 which passes through the assembling recess 5131 of the swinging portion 513. That is, the nut can be fastened on a side of the swinging portion 513 away from the mass block 52 to fix the mass block 52. Moreover, when the mass block 52 is light, a mass of the nut can be taken into account along with a mass of the mass block 52 to adjust the natural frequency of the damping structures 50.

The assembling protrusion 522 is adjustably assembled in the assembling recess 5131 by being movably disposed in the assembling recess 5131 relative to the swinging portion 513. Accordingly, a position in which the mass block 52 is disposed in the assembling recess 5131 can be adjusted according to a target vibration frequency to be absorbed to ensure that the natural frequency of the damping structures 50 can match the target vibration frequency of the vibration. Therefore, when the vibrations generated by the fans 40 during operation are transferred to the damping structures 50, a resonance will be generated if the natural frequency of the damping structures 50 matches the vibration frequency of the fans 40, such that a strong amplitude enhancement effect may be generated by the damping structures 50. The length L2 of the swinging portion 513 can be increased to reduce the stiffness of the elastic member 51, thereby lowering the natural frequency of the damping structures 50. In addition, the mass block 52 with a mass corresponding to the actual vibration frequency may be adopted.

In this embodiment, for example, for the fans 40 with the target vibration frequency ranging from 300 Hz to 400 Hz, the mass block 52 weighing 42 grams may be adopted, and a distance L4 between the assembling protrusion 522 of the mass block 52 and an end of the assembling recess 5131 close to the supporting portion 512 may be 18 millimeters. Accordingly, the natural frequency of the damping structures 50 can match the target vibration frequency, such that the damping structures 50 can absorb the vibrations of the target vibration frequency generated by the fans 40 during operation effectively. In addition, for example, for the fans 40 with the sensitive frequency ranging from 1450 Hz to 1550 Hz, the mass block 52 weighing 48 grams may be adopted, and a distance L4 between the assembling protrusion 522 of the mass block 52 and an end of the assembling recess 5131 close to the supporting portion 512 may be 6 millimeters. Accordingly, the natural frequency of the damping structures 50 can match the sensitive frequency, such that the damping structures 50 can absorb the vibrations of the sensitive frequency generated by the fans 40 during operation effectively and reduce an adversely effect on the hard disk drive 30. Therefore, the natural frequency of the resonator can be correspondingly adjusted by adjusting the distance between the assembling protrusion 522 of the mass block 52 and the end of the assembling recess 5131 close to the supporting portion 512. The greater the aforementioned distance is, the lower the stiffness of the elastic member 51 is, and thus, the lower the natural frequency of the resonator is. In addition, the greater the mass of the mass block 52 is, the lower the natural frequency of the resonator is.

In this embodiment, the two opposite ends of the supporting portion 512 are respectively connected to the mounting portion 511 and the swinging portion 513, and the mounting portion 511 and the swinging portion 513 are located on the same side of the supporting portion 512, such that the elastic member 51 is, for example, shaped like a numeral “7”. The swinging portion 513 is swingable relative to the supporting portion 512 and the mounting portion 511. The natural frequency of the damping structures 50 can be correspondingly adjusted by adjusting the mass of the mass block 52 and the position in which the mass block 52 is disposed in the assembling recess 5131. Therefore, the vibrations can be damped by the damping structures 50 of the electronic device 10 effectively under different operating conditions. When the natural frequency of the damping structures 50 matches the vibration frequency of the fans 40, the resonance will be generated, and the strong amplitude enhancement effect may be generated by the damping structures 50. The interaction between the vibrations generated by the fans 40 during operation and the elastic member 51 of the damping structures 50 can be conducted along the path where the vibrations are transferred. Specifically, the vibrations generated by the fans 40 during operation may be transferred to the elastic member 51 of the damping structures 50. The swinging portion 513 can absorb the vibrations effectively, and convert the vibrations into kinetic energy of the swinging portion 513. Accordingly, the vibrations generated by the fans 40 during operation can be confined within the damping structures 50, thereby dissipating, for example, 71% of a total vibrating energy and 53% of a peak vibrating energy. In addition, the damping structures 50 can be facilitated to be assembled in the limited space between the hard disk drive 30 and the fans 40 and be prevented from interfering with other obstructions disposed in the aforementioned space via the magnetic member 60, and thus, the damping structures 50 can be adaptable to different specifications of the chassis 20. Accordingly, the assembly cost of the damping structures 50 can be lowered while maintaining the damping effect of the damping structures 50.

In addition, since the assembling protrusion 522 is adjustably assembled in the assembling recess 5131 by being movably disposed in the assembling recess 5131 relative to the swinging portion 513, the position in which the mass block 52 is disposed in the assembling recess 5131 can be adjusted according to the actual vibration frequency. Accordingly, the damping structures 50 may effectively absorb vibrations of different frequency in a flexible manner.

In this embodiment, a side of the mass block 52 away from the assembling protrusion 522 has a mounting recess 523. The mounting recess 523, for example, has a threaded structure (not shown), and is configured to allow the additional mass blocks 52 to be mounted for adjusting the overall mass of the mass blocks 52.

In this embodiment, there are multiple fans 40 and multiple damping structures 50, but the invention is not limited thereto. In other embodiments, there may be one fan and one damping structure merely. In other embodiments, multiple damping structures with different natural frequencies may be disposed in the chassis, and are spaced apart from each other.

In this embodiment, the mounting portion 511 is fixed to the chassis 20 via the magnetic member 60, but the invention is not limited thereto. In other embodiments, the mounting portion may have a recess for a fastener to be disposed therein instead of the magnetic member, such that the mounting portion can be fastened to the chassis.

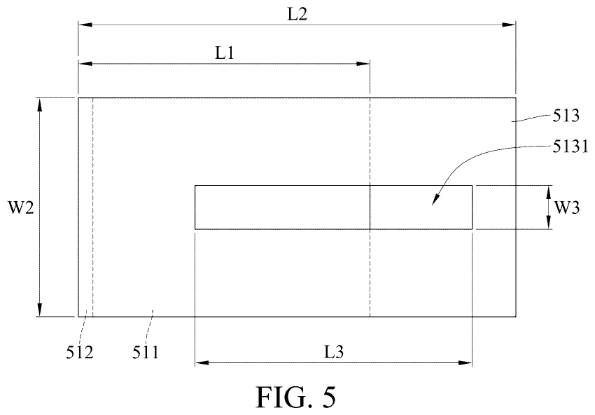

Please refer to FIG. 5 and FIG. 6, where FIG. 5 is a top view of the elastic member 51 of one of the damping structures 50 of the electronic device 10 in FIG. 2. In this embodiment, when the natural frequency of the damping structures 50 is greater than or equal to 300 Hz and less than or equal to 400 Hz, a ratio of the length L2 of the swinging portion 513 to the length L1 of the mounting portion 511 may be greater than or equal to 3 and less than or equal to 6, a ratio of the length L2 of the swinging portion 513 to a length L3 of the assembling recess 5131 may be greater than or equal to 1.5 and less than or equal to 1.8, a ratio of the length L2 of the swinging portion 513 to a width W2 of the swinging portion 513 may be greater than or equal to 1.7 and less than or equal to 2.3, a ratio of the length L1 of the mounting portion 511 to a height H of the elastic member 51 may be greater than or equal to 1.1 and less than or equal to 1.7, a ratio of the length L2 of the swinging portion 513 to the height H of the elastic member 51 may greater than or equal to 4 and less than or equal to 4.6, and a ratio of the length L3 of the assembling recess 5131 to a width W3 of the assembling recess 5131 may be greater than or equal to 6 and less than or equal to 6.6. In the preferred embodiment, the height H of the elastic member 51 is, for example, greater than or equal to 6 millimeters and less than or equal to 8 millimeters, but the invention is not limited thereto. Specifically, the natural frequency and swinging mode of the damping structures 50 can be correspondingly varied by adjusting the length L2 of the swinging portion 513, the position in which the mass block 52 is disposed in the assembling recess 5131 and the mass of the mass block 52.

According to the damping structure and the electronic device disclosed in the above embodiment, the two opposite ends of the supporting portion are respectively connected to the mounting portion and the swinging portion, and the mounting portion and the swinging portion are located on the same side of the supporting portion, such that the elastic member is, for example, shaped like a numeral “7”. The swinging portion is swingable relative to the supporting portion and the mounting portion. The natural frequency of the damping structures can be correspondingly adjusted by adjusting the mass of the mass block and the position in which the mass block is disposed in the assembling recess. Therefore, the vibrations can be damped by the damping structures of the electronic device effectively under different operating conditions. When the natural frequency of the damping structures matches the vibration frequency of the fans, the resonance will be generated, and the strong amplitude enhancement effect may be generated by the damping structures. The interaction between the vibrations generated by the fans during operation and the elastic member of the damping structures can be conducted along the path where the vibrations are transferred. Specifically, the vibrations generated by the fans during operation may be transferred to the elastic member of the damping structures. The swinging portion can absorb the vibrations effectively, and convert the vibrations into kinetic energy of the swinging portion. Accordingly, the vibrations generated by the fans during operation can be confined within the damping structures, thereby dissipating, for example, 71% of a total vibrating energy and 53% of a peak vibrating energy. In addition, the damping structures can be facilitated to be assembled in the limited space between the hard disk drive and the fans and be prevented from interfering with other obstructions disposed in the aforementioned space via the magnetic member, and thus, the damping structures can be adaptable to different specifications of the chassis. Accordingly, the assembly cost of the damping structures can be lowered while maintaining the damping effect of the damping structures.

In addition, since the assembling protrusion is adjustably assembled in the assembling recess by being movably disposed in the assembling recess relative to the swinging portion, the position in which the mass block is disposed in the assembling recess can be adjusted according to the actual vibration frequency. Accordingly, the damping structures may effectively absorb vibrations of different frequency in a flexible manner.

In this embodiment, the damping structures of the invention can be applied to a server. The server can apply artificial intelligence (AI) computing, edge computing, and can also be used as a 5G server, a cloud server or a Vehicle-to-everything server.

It will be apparent to those skilled in the art that various modifications and variations can be made to the invention. It is intended that the specification and examples be considered as exemplary embodiments only, with the scope of the invention being indicated by the following claims.

What is claimed is:

1. A damping structure, configured to be disposed in a chassis and comprising:
an elastic member, comprising a mounting portion, a supporting portion and a swinging portion, wherein the mounting portion is configured to be disposed in the chassis, two opposite ends of the supporting portion are respectively connected to the mounting portion and the swinging portion, the mounting portion and the swinging portion are located on a side of the supporting portion, and the swinging portion is swingable relative to the supporting portion and the mounting portion; and
a mass block, disposed on the swinging portion.

2. The damping structure according to claim 1, wherein the swinging portion has an assembling recess, the mass block has an assembling protrusion, and the assembling protrusion is adjustably assembled in the assembling recess by being movably disposed in the assembling recess relative to the swinging portion.

3. The damping structure according to claim 2, wherein a ratio of a length of the swinging portion to a length of the assembling recess is greater than or equal to 1.5 and less than or equal to 1.8, and a ratio of the length of the assembling recess to a width of the assembling recess is greater than or equal to 6 and less than or equal to 6.6.

4. The damping structure according to claim 1, wherein a length of the swinging portion is greater than a length of the mounting portion.

5. The damping structure according to claim 1, wherein a ratio of a length of the swinging portion to a length of the mounting portion is greater than or equal to 3 and less than or equal to 6, a ratio of the length of the swinging portion to a width of the swinging portion is greater than or equal to 1.7 and less than or equal to 2.3, a ratio of the length of the mounting portion to a height of the elastic member is greater than or equal to 1.1 and less than or equal to 1.7, and a ratio of the length of the swinging portion to the height of the elastic member is greater than or equal to 4 and less than or equal to 4.6.

6. An electronic device, comprising:
a chassis;
a hard disk drive, disposed in the chassis;
at least one fan, disposed in the chassis; and
at least one damping structure, located between the hard disk drive and the at least one fan and comprising:
an elastic member, comprising a mounting portion, a supporting portion and a swinging portion, wherein the mounting portion is disposed in the chassis, two opposite ends of the supporting portion are respectively connected to the mounting portion and the swinging portion, the mounting portion and the swinging portion are located on a side of the supporting portion, and the swinging portion is swingable relative to the supporting portion and the mounting portion; and
a mass block, disposed on the swinging portion.

7. The electronic device according to claim 6, wherein the swinging portion has an assembling recess, the mass block has an assembling protrusion, and the assembling protrusion is adjustably assembled in the assembling recess by being movably disposed in the assembling recess relative to the swinging portion.

8. The electronic device according to claim 7, wherein a ratio of a length of the swinging portion to a length of the assembling recess is greater than or equal to 1.5 and less than or equal to 1.8, and a ratio of the length of the assembling recess to a width of the assembling recess is greater than or equal to 6 and less than or equal to 6.6.

9. The electronic device according to claim 6, wherein a length of the swinging portion is greater than a length of the mounting portion.

10. The electronic device according to claim 6, wherein a ratio of a length of the swinging portion to a length of the mounting portion is greater than or equal to 3 and less than or equal to 6, a ratio of the length of the swinging portion to a width of the swinging portion is greater than or equal to 1.7 and less than or equal to 2.3, a ratio of the length of the mounting portion to a height of the elastic member is greater than or equal to 1.1 and less than or equal to 1.7, and a ratio of the length of the swinging portion to the height of the elastic member is greater than or equal to 4 and less than or equal to 4.6.
